(19) United States
(12) Patent Application Publication
(10) Pub. No.: US 2005/0075063 A1
(43) Pub. Date: Apr. 7, 2005

(54) Ventilation device for a passenger compartment with noise attenuator

(75) Inventors: Fabrice Ailloud, Guyancourt (FR); Said Naji, Elancourt (FR); Djahanchah Bamdad-Soufi, Rambouillet (FR)

Correspondence Address: Valeo Climate Control Corp;Intellectual Property Dept, 4100 North Atlantic Boulevard, Auburn Hills, MI, 48326, US

(73) Assignee: Valeo Climatisation S.A.

(21) Appl. No.: 10/848,633

(22) Filed: May 19, 2004

(30) Foreign Application Priority Data
May 27, 2003 (FR) 03 06416

(51) Int. Cl. B60H 1/00

(52) U.S. Cl. 454/139

(57) ABSTRACT

A ventilation device for a passenger compartment (H), specifically for an automobile, includes a casing (1) with an exterior air intake (4) and a recirculated air intake (5) that supply a fan (9-13) with a variable suction airflow rate that is housed inside the casing, controlled by at least one variable-position air intake shutter (8). At least one of the exterior air intakes (4) and recirculated air intakes (5) includes attenuation means (15) capable of limiting propagation toward the outside of the casing (1), at least on the passenger compartment (H) side, of the sound waves generated by the airflow circulating in the air intakes (4, 5).

The invention relates to ventilation devices for passenger compartments, specifically for automobiles.

It more particularly relates to ventilation devices for passenger compartments including a casing that is equipped, on the one hand, with an exterior air intake and a recirculated air intake supplying a fan housed inside the casing under the control of at least one air intake shutter, and on the other hand, with a command module responsible for managing the position of the air intake shutter and the airflow drawn by the fan.

As the expert knows, the acoustic behavior of these ventilation devices depends partly on their air intakes. The latter cause airflow disturbances, in particular when their speed is higher than 10 m/s.

More precisely, the speed variations whose airflows are the matter under discussion are transformed into pulsations of pressure that generate noises whose frequencies are at least partly located in the audible frequency band. These noises, whose intensity also depends on the operating mode of the ventilation device (recirculated air or fresh air), are propagated into the passenger compartment, via the air ducts, the acoustic transparency zones, and the structural elements of the vehicle, creating an auditory annoyance for its occupants.

The purpose of the invention is therefore to improve this situation.

To this end, it proposes a passenger compartment ventilation device, specifically for automobiles, of the type presented in the introduction, and of which at least one of the exterior air intakes and recirculated air intakes is equipped with attenuation means responsible for limiting the propagation towards the outside of the casing, at least on the side of the passenger compartment, of the sound waves produced by airflows circulating in these air intakes.

In a particularly advantageous embodiment, the attenuation means include an acoustic screen.

This acoustic screen can be arranged so as to reflect (or return) the sound waves towards one side of the vehicle, placed at the interface between the passenger compartment and the engine compartment, such as the firewall, for example.

As a variation or supplement, the attenuation means may include a coating, installed on the inner wall of the acoustic screen (which is exposed to the airflow), and intended to absorb the sound waves, at least in part.

In addition, at least part of the inner walls of the casing (which are exposed to the airflow) can include auxiliary attenuation means, such as, for example, a coating intended to absorb the sound waves at least in part. The latter is then preferably installed on the relevant part of the inner walls of the casing.

The coating is preferably made of a porous-type material. This could, for example, be open-cell foam or a felt-type material.

Preferably, the acoustic screen marks off at least part of the recirculated air intakes and exterior air intakes. This acoustic screen may then consist of a wall equipped with an end part that protrudes out of the casing over a first selected length, upstream of at least one of the previously-mentioned recirculated air intakes and exterior air intakes. This first length is preferably selected depending upon a second length, perpendicular to the plane defined roughly by the end part of the partition, and along which extends an opening that gives access to at least one of the previously-mentioned recirculated air intakes and exterior air intakes.

Additionally, the acoustic screen can be implanted at least partially outside or inside the casing.

Lastly, the opening that gives access to the recirculated air intake and the opening that gives access to the exterior air intake may have selected hydraulic diameters.

Other characteristics and advantages of the invention will emerge upon examination of the following detailed description and attached drawings, wherein:

FIG. 1 illustrates in diagram form, in median cross-section view, part of a first embodiment of the automobile ventilation device according to the invention,

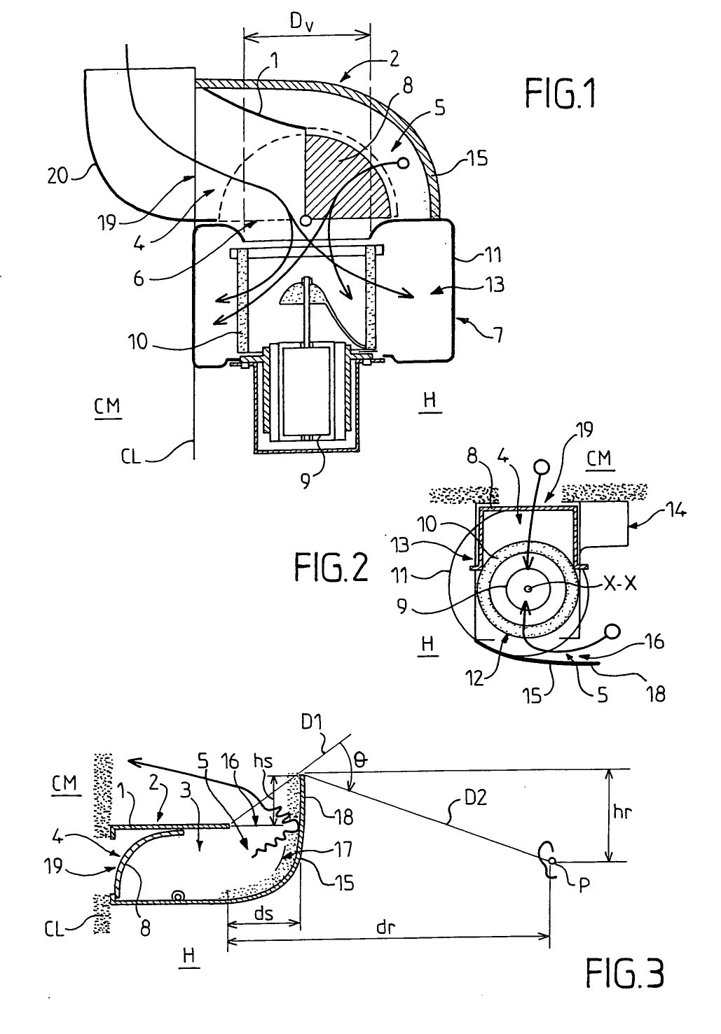

FIG. 2 illustrates in diagram form, in median longitudinal cross-section view, the first embodiment of FIG. 1,

FIG. 3 illustrates in diagram form a mechanism for noise attenuation in an automobile ventilation device according to the invention,

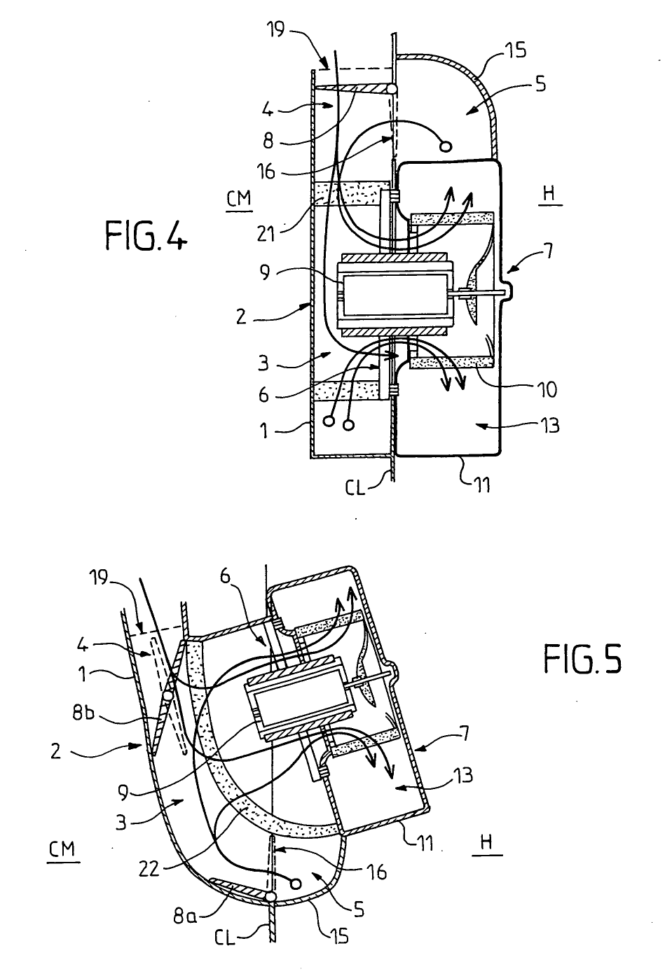

FIG. 4 illustrates, in median cross-section view, a second embodiment of the automobile ventilation device according to the invention, and

FIG. 5 illustrates, in median cross-section view, a third embodiment of the automobile ventilation device according to the invention.

The attached drawings may not only be used for supplementing the invention, but also for contributing to its definition, if necessary.

We first refer to FIGS. 1 to 3 to describe a first embodiment of the ventilation device according to the invention.

In the following we assume, by way of example, that the ventilation device is part of a heating installation consisting of an air supply casing 1, supplying an air distribution and treatment casing (not shown in the figures) for distributing treated air inside the passenger compartment H of an automobile, at the distribution vents. Casing 1 is, for example, integral to the firewall CL placed at the interface between the engine compartment CM and the passenger compartment H.

The illustrated ventilation device (or air supply casing) 1 includes walls that mark off an air supply chamber 3 in a first (upper) part 2. The walls that mark off the chamber 3 have two openings 4 and 5 and one outlet 6 that connects to a second (lower) part 7 of the casing 1.

The first opening 4 is connected to an exterior air supply pipe 20 that is implanted, in the embodiment example, inside the engine compartment CM. It is thus referred to as the “exterior air intake” (or fresh air intake). The second opening 5 connects to the passenger compartment H, optionally via a pipe. It is thus referred to as the “recirculated air intake.”

In addition, chamber 3 houses an air selection device 8, shown here as a drum shutter, making it possible for a command module (not shown) to select the type of air supply flow (exterior (or fresh) or recirculated). However, as will be seen, one could instead utilize a so-called butterfly shutter or a so-called flag shutter.

The walls that mark off the lower part 7 of the casing 1 house an engine fan unit in a central part. This engine fan unit consists of an electric engine 9 that makes a turbine 10 (or wheel) rotate around a shaft XX at various speeds. The external walls of this lower part 7 of the casing 1, together with the peripheral part 12 of the turbine 10, mark off a fan scroll 13 that is rolled up in a spiral around the turbine 10 and whose outlet 14 connects to the heating installation distribution and treatment casing.

When the turbine 10 is placed in rotation by means of the electric engine 9, it axially takes in air that is in the supply chamber 3, and that comes either from the exterior air intake 4, or from the recirculated air intake 5, or from the two intakes simultaneously. The turbine ejects, more or less tangentially to its peripheral part 12, the air thus drawn into the fan scroll 13, in order to supply the distribution and treatment casing with forced, fresh, recirculated, or mixed air. The airflow drawn in by the fan is managed by the command module.

According to the invention, the ventilation device consists of noise attenuation means, preferably made as an acoustic screen 15 installed as a wall that is integral to the casing 1. This screen 15 marks off, along with one of the walls of the upper part 2 of the casing 1, the recirculated air intake 5, and in particular its intake opening 16 through which the recirculated air penetrates.

As is better illustrated in FIG. 3, the acoustic screen 15 may have a shape that is selected in order to reflect (or return) sound waves, which are generated by disturbances of the airflow in the chamber 3, towards the engine compartment CM (and more precisely towards the firewall CL), and thus away from the passenger compartment H. Preferably, the acoustic screen 15 has a curved shape, directed towards the firewall CL. In other words, the acoustic wall creates, between the noise-generating part of the ventilation device and the passenger compartment H, an acoustically-opaque zone, thus considerably reducing the noise level.

As a variation of or supplement to this reflection configuration for the screen 15, the attenuation means may include a coating 17 responsible for at least partially absorbing the sound waves generated in the chamber 3. Preferably, as illustrated in FIG. 3, the coating is made of an absorbent material 17, attached to the inner side of the acoustic screen 15, which is exposed to the airflow in the recirculated air intake 5. In another embodiment, the screen could consist of an acoustically-absorbent material.

This coating material 17 is preferably porous. It could, for example, be made of open-cell foam or of a felt material.

Such an absorbent material may also be installed on the inner side (exposed to airflows) of one or more other walls of the casing 1, such as, for example, on the walls that mark off the chamber 3, in particular in the vicinity of the exterior air intake, and/or the outer walls 11 that mark off the fan scroll 13. When it is placed elsewhere than on the acoustic wall 15, the absorbent material constitutes auxiliary attenuation means.

In addition, as is illustrated in FIGS. 2 and 3, the acoustic screen 15 may include an end part 18 that extends past the recirculated air intake 5, and more precisely past (upstream of) the intake opening 16, over a first selected length hs. Preferably, this end part 18 extends out in a plane that is roughly perpendicular to the plane containing the intake opening 16.

This extension 18 of the acoustic wall 15 makes it possible to set the level of noise attenuation (apart from the action of an optional absorbent material 17).

In fact, as is illustrated in FIG. 3, one can define an angle θ between a straight line D1, passing through the end of the end part 18 of the acoustic wall 15 and the end of the intake opening 16, opposite the acoustic wall 15, and a straight line D2, passing through the end of the end part 18 of the acoustic wall 15 and a point P that corresponds, for example, to the location of an ear of an occupant seated inside the passenger compartment H.

If we assume that point P is fixed, we see that the angle θ can be varied by varying the first length hs and/or the width (or second length) ds of the intake opening 16. hs is, for example, equal to approximately 10 millimeters.

By defining:
a parameter dr as the distance horizontally separating point P from the end of the intake opening 16 through which line D1 passes (dr is, for example, equal to approximately 1 meter), and
a parameter hr as the distance vertically separating point P from the end of the end part 18 of the acoustic wall 15, through which lines D1 and D2 pass, (hr is, for example, equal to approximately 110 millimeters),
   we may then obtain the following equation: θ=arctan[hr/(dr−ds)]+arctan[hs/ds].

And by defining:
a parameter m as the mass of the acoustic wall 15,
a parameter ω as the frequency of the acoustic waves (noises),
a parameter ρ as the density of the acoustic wall 15, and
a parameter c as the speed of sound in the air,
   we may then roughly define the absorption coefficient R of the acoustic wall 15 (in decibels (or dB)) using Rayleigh's equation: R=20.log[(m.ω.cos θ)/(2.ρ.c)]. We then see that noise attenuation increases along with the sound frequency ω and/or with the angle θ.

In order to further attenuate noises generated in the chamber 3, one can also select, in appropriate fashion, the dimensions (specifically, ds) of the intake opening 16 of the recirculated air intake 5 and of the intake opening 19 of the external air intake 4.

Indeed, the respective dimensions of the two intake openings 16 and 19 are selected depending upon the desired flow power sought in the recirculated-air and fresh-air operating modes. The power differences between these two operating modes generate a noticeable difference in the noise heard in the passenger compartment H.

The appropriate dimensions of an intake opening 16 or 19 depend on the hydraulic diameter (Dhr or Dhf) of the surface occupied by the airflow (recirculated or exterior) passing through the intake opening. By definition, this hydraulic diameter (Dhr or Dhf) is equal to four times the surface of the opening divided by the perimeter of this surface. In addition, the hydraulic diameter (Dhr or Dhf) must be as close as possible to what the expert refers to as the internal diameter of the shell (Dv) of the fan 9 (FIG. 1).

We may then show, by defining the parameter a as being the equivalent opening of the porous absorbent material expressed as a percentage of the total surface, that the optimal conditions for attenuation, in the presence of an acoustic wall 15 equipped with an end part 18, can be obtained in the presence of the following inequalities:
0.02≦ds/dr≦0.2;
0≦hs/hr≦1;
0.02≦(4.a)/(π.Dhr2)≦0.5;
0.9≦Dhr/Dv; and
0.6≦Dhr/Dhf≦1.2.

The equivalent opening of the absorbent material is defined by the sum of the surfaces of the openings that the total surface divides (total surface of flow rate).

It should be noted that the acoustic wall 15 may be either integral to the casing 1; for example, when the casing is made by molding a material such as a polymer, or an added-on component.

We now refer to FIG. 4, which describes a second embodiment of the ventilation device according to the invention.

In this second embodiment, the two parts 2 and 7 of the casing 1 are not placed in approximately horizontal, but rather in approximately vertical positions. The first part 2 of the casing 1, which marks off chamber 3, is now located in the engine compartment CM and houses, in a central part, part of the electric engine 9, while the second part 7 of the casing 1 is now located in the passenger compartment H and houses the remainder of the engine fan unit (turbine 10, fan scroll 13, and remainder of the electric engine 9).

In addition, the chamber 3 houses a circular-type air filter 21, inside which an opening through which an electric engine 9 can pass is made.

Moreover, due to the proximity of the recirculated air intake 5 and the exterior air intake 4, the airflow selection device 8 is a flag-type shutter.

The attenuation means are still made as an acoustic screen 15 placed at the level of the recirculated air intake 5. The acoustic screen 15 is integral to the upper part of the second part 7 of the casing 1 as well as to the firewall CL or to the first part 2 of the casing 1. This acoustic screen 15 acts as an acoustically-opaque zone for the recirculated air intake 5 and the exterior air intake 4 because of their immediate proximity, thus making it possible to considerably reduce the noises generated in both operating modes of the ventilation device.

We now refer to FIG. 5 in order to describe a third embodiment of a ventilation device according to the invention.

This third embodiment is a variation of the two embodiments previously described. Here, the two parts 2 and 7 of the casing 1 are placed in tilted positions. The first part 2 of the casing 1, which marks off the chamber 3, is located partly inside the engine compartment CM and partly inside the passenger compartment H and houses part of the electric engine 9, while the second part of the casing 7 is located inside the passenger compartment H and houses the remainder of the engine fan unit (turbine 10, fan scroll 13 and remainder of the electric engine 9).

In addition, the chamber 3 houses a “Plier”-type air filter 22, inside which an opening through which the electric engine 9 may pass is made.

The recirculated air intake 5 and the exterior air intake 4 are placed here at two roughly opposite ends (lower and upper) of the casing 1. Given this fact, the airflow selection device 8 includes a flag-type shutter 8a in order to control the access of the recirculated air into the chamber 3, and a butterfly-type shutter 8b in order to regulate the access of the exterior air into the chamber 3. The attenuation means are still made as an acoustic screen 15 placed at the level of the recirculated air intake 5, in the lower part of the casing 1. The acoustic screen 15 is integral to the second part 7 of the casing 1 as well as to the first part 2 of the casing 1. This acoustic screen 15 is used as an acoustically-opaque zone for the recirculated air intake 5.

The invention is not limited to the embodiments of the ventilation device described above, cited only by way of example, but includes all of the variations that the expert might envisage within the scope of the claims listed below.

Thus, we have described embodiments in which the acoustic screen was placed at the recirculated air intake. But this screen could also be placed at the external air intake, or at the recirculated air intake and the external air intake; it could also cover all or part of the fan scroll and the engine mount.

1. Ventilation device for a passenger compartment (H), specifically for an automobile, of a type including a casing (1) equipped with an exterior air intake (4) and with a recirculated air intake (5), suitable for supplying a fan (9-13) with variable-flow air intake and housed inside the casing, under the control of at least one variable-position air intake shutter (8), wherein at least one of the exterior air intakes (4) and recirculated air intakes (5) includes attenuation means (15,17) installed to limit the propagation towards the outside of the casing (1), at least on the side of the passenger compartment (H), of the sound waves produced by the airflow circulating in the abovementioned air intakes (4,5).

2. Device according to claim 1, wherein the attenuation means (15,17) include an acoustic screen (15).

3. Device according to claim 2, wherein the acoustic screen (15) is arranged so as to reflect the sound waves towards one wall (CL) of the vehicle, placed at the interface between the passenger compartment (H) and an engine compartment (CM).

4. Device according to claims 2, wherein the attenuation means (15,17) include a coating (17), installed on an internal wall of the acoustic screen (15), exposed to the airflow, and able to at least partially absorb the sound waves.

5. Device according to claims 1, wherein at least one part of the inner walls of the casing (1), exposed to the airflow, includes auxiliary attenuation means.

6. Device according to claim 5, wherein the auxiliary attenuation means include a coating (17) installed on said part of the inner walls of the casing (1) and able to at least partially absorb the sound waves.

7. Device according to claim 4 to, wherein the coating (17) is made of porous-type material.

8. Device according to claim 7, wherein the material is an open-cell foam or a felt-type material.

9. Device according to claim 2, wherein the acoustic screen (15) marks off at least part of at least one of the recirculated air intakes (5) and exterior air intakes (4).

10. Device according to claim 9, wherein the acoustic screen (15) includes a wall equipped with a end part (18) that extends, over a first selected length (hs), out of the casing (1), upstream of at least one of the recirculated air intakes (5) and exterior air-intakes (4).

11. Device according to claim 10, wherein the first length (hs) is selected depending upon the function of a second length (ds), perpendicular to the plane roughly defined by the end part (18), and along which extends at least one opening (16, 19) giving access to at least one of the recirculated air intakes (5) and exterior air intakes (4).

12. Device according to claim 10, wherein the acoustic screen (15) is implanted, at least partially, outside of the casing (1).

13. Device according to claim 10, wherein the acoustic screen (15) is implanted, at least partially, inside the casing (1).

14. Device according to claim 10, wherein the opening (16) giving access to the recirculated air intake (5) and the opening (19) giving access to the exterior air intake (4) represent selected hydraulic diameters (Dhr, Dhf).
